(19) United States
(12) Patent Application Publication
(10) Pub. No.: US 2009/0108069 A1
(43) Pub. Date: Apr. 30, 2009

(54) BARCODE READER

(75) Inventor: Tomomi MASHIKO, Hino-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/257,522

(22) Filed: Oct. 24, 2008

(30) Foreign Application Priority Data
Oct. 31, 2007 (JP) 2007-283808

(51) Int. Cl. G06K 7/10

(52) U.S. Cl. 235/462.25

(57) ABSTRACT

A barcode reader converts an electric signal generated from reflection light received from a barcode to a differential signal by a differential processing unit, and detects an extreme of the differential signal by an extreme detection unit. An extreme validity determination unit determines whether the detected extreme is a valid extreme, and information on the extreme determined to be valid is once stored in a memory. On the basis of the information of the extreme stored in the memory, a barcode width data generation unit performs binarization processing. An inter-extreme time difference is measured to determine whether the extreme is a valid extreme or noise, and the extreme determined to be noise is not stored, such that the time required for processing and load are reduced.

### CROSS-REFERENCE TO RELATED APPLICATIONS

This application is based upon and claims the benefit of priority from prior Japanese Patent Application No. 2007-283808, filed Oct. 31, 2007, the entire contents of which are incorporated herein by reference.

### BACKGROUND OF THE INVENTION

1. Field of the Invention

The present invention relates to a barcode reader which saves the storage capacity of a memory when a read signal of a barcode symbol contains much noise.

2. Description of the Related Art

In general, barcode symbols are widely used as means for representing information on the management of articles in, for example, sale of articles, physical distribution or manufacturing processes.

FIG. 13 is a block diagram schematically showing an example of the configuration of a known barcode reader for reading described information by swing a mirror to radiate scanning light for reading. FIG. 14 is a diagram showing examples of signals in the barcode reader shown in FIG. 13.

This barcode reader 10E comprises a drive control unit 20a, a scanning mirror 20, a collection mirror 30, a reflecting mirror 40, a light source control unit 50, a light source 60, a sensor unit 70A, a signal conversion unit 70B, a differential processing unit 80, a peak hold/bottom hold detection unit 90E, a threshold value setting unit 100E, a comparison unit 110E, and a barcode width data generation unit 120E. Signal processing by this barcode reader 10E is described below.

As shown in FIG. 14, a barcode symbol 200 includes a set of a plurality of thick elements and thin elements. The coefficient of the light reflection from the elements is relatively low, and changes depending on the thickness of the element. Therefore, an obtained voltage signal (information signal) has a minimum substantially corresponding to the thickness of the element.

A photoelectrically converted signal (current signal) generated by the light receiving unit 70A is converted to a voltage signal by the signal conversion unit 70B. Further, this voltage signal is input to the differential processing unit 80 and converted to a differential signal. FIG. 14 shows one example of the differential signal.

Then, the differential signal is separated into noise and a signal. The differential signal is input to both the peak hold/bottom hold detection unit 90E and the comparison unit 110E. The peak hold/bottom hold detection unit 90E generates and outputs a peak hold value and a bottom hold value. This output is input to the threshold value setting unit 100E where it is subjected to voltage division at a predetermined ratio and generated as a threshold signal serving as a determination standard.

Then, the threshold signal is input to the comparison unit 110E, and compared with the above-mentioned differential signal. As a result of this comparison, a signal having a level equal to or more than a threshold value out of the differential signal is determined to be a valid signal, and output as a plurality of comparison signals. On the other hand, a signal at a level less than the threshold signal is determined to be noise. In addition, in an example shown in FIG. 14 described later, a signal corresponding to the thin element is lower than the threshold value which determines validity, and is not determined to be a valid signal. The barcode width data generation unit 120E generates barcode width data from these comparison signals.

As a technique for noise elimination, for example, Jpn. Pat. Appln. KOKAI Publication No. 10-320496 has disclosed a technique which processes a photoelectrically converted signal generated by a light receiving unit, and then binarizes the signal, and ignores pulses less than a predetermined range to eliminate noise.

When such a conventional signal processing process includes analog-to-digital conversion and digital signal processing, the amount of data to be processed increases if an obtained information signal (differential signal) contains much noise, so that a storage element with high storage capacity is used. Moreover, as shown in FIG. 14, when the differential signal contains much noise, small pulses equal to or less than a predetermined range are ignored or validity is determined by the threshold value of a voltage as shown in FIG. 13, which cannot be said to be sufficient measures.

### BRIEF SUMMARY OF THE INVENTION

The present invention provides a barcode reader capable of saving the storage capacity of a memory for storing an extreme and capable of reducing the time required for binarization processing and load on a barcode reading element.

Furthermore, the present invention provides a barcode reader comprising: a light source; a light scanning section which scans a barcode symbol with light generated from the light source; a light collecting section which collects reflection light reflected by the barcode symbol; a sensor section which converts a light signal collected in the light collecting section to an electric signal; a differential processing section which generates a differential signal from the electric signal generated by the sensor section; an extreme detection section which detects an extreme of the differential signal generated by the differential processing section; an extreme validity determination section which determines whether the extreme detected by the extreme detection section is a valid extreme; a memory which stores information on the extreme determined to be valid by the extreme validity determination section; and a barcode width generation section which performs binarization processing on the basis of information on the extreme stored in the memory.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing the configuration of a barcode reader according to a first embodiment;

FIG. 2 is a flowchart showing processing in the barcode reader according to the first embodiment;

FIG. 3A is a diagram showing one example of a differential signal in the first embodiment;

FIG. 3B is a diagram showing an extreme corresponding to the differential signal shown in FIG. 3A;

FIG. 4 is a flowchart for explaining binarization processing;

FIG. 5 is a block diagram schematically showing the configuration of a barcode reader according to a second embodiment;

FIG. 6A is a first half of a flowchart showing processing in the barcode reader according to the second embodiment;

FIG. 6B is a second half of the flowchart showing the processing following FIG. 6A;

FIG. 7 is a flowchart showing details of validity determination processing based on an extreme voltage;

FIG. 8A shows one example of the validity determination processing based on the extreme voltage in connection with a maximum produced in the vicinity of a place where the maximum is originally used as a peak in binarization processing;

FIG. 8B shows one example of the validity determination processing based on the extreme voltage in connection with a maximum produced in the vicinity of a place where the maximum is originally used as a bottom in the binarization processing;

FIG. 9 is a block diagram schematically showing the configuration of a barcode reader according to a third embodiment;

FIG. 10A is a first half of a flowchart showing processing in the barcode reader according to the third embodiment;

FIG. 10B is a second half of the flowchart showing the processing following FIG. 10A;

FIG. 11 is a block diagram schematically showing the configuration of a barcode reader according to a fourth embodiment;

FIG. 12 is a flowchart showing processing in the barcode reader according to the fourth embodiment;

FIG. 13 is a block diagram schematically showing the configuration of a conventional barcode reader; and

FIG. 14 is a diagram showing examples of signals in the conventional barcode reader.

### DETAILED DESCRIPTION OF THE INVENTION

Embodiments of the present invention will hereinafter be described in detail with reference to the drawings.

### First Embodiment

A first embodiment of the present invention is described.

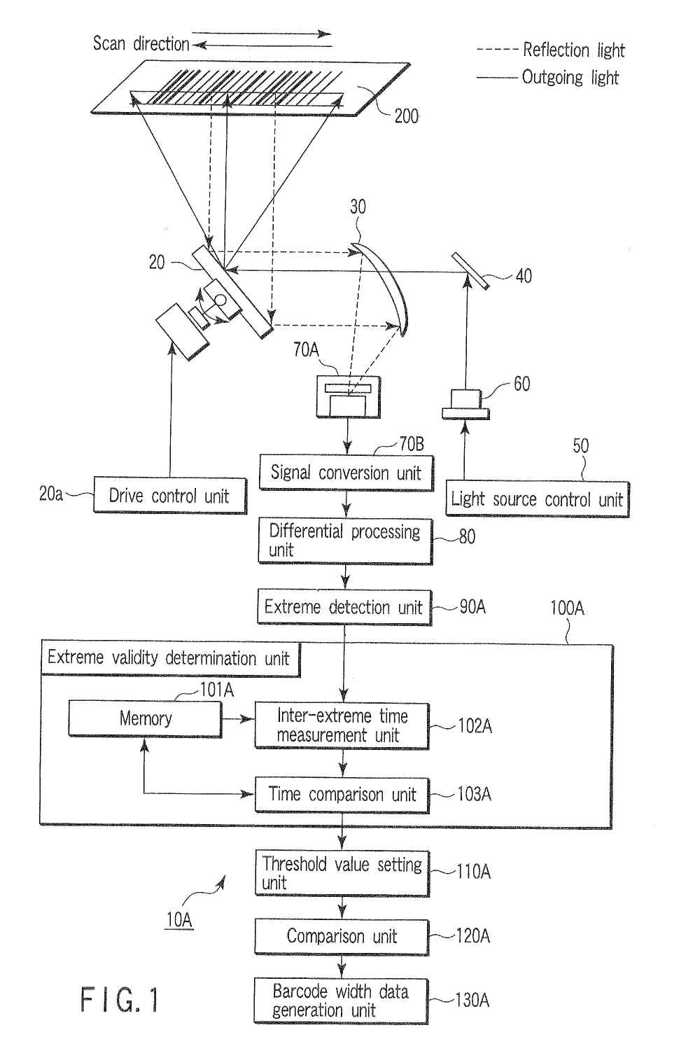

FIG. 1 is a block diagram schematically showing the configuration of a barcode reader 10A according to the first embodiment.

This barcode reader 10A comprises a drive control unit 20a, a scanning mirror 20 controlled by the drive control unit, a collection mirror 30, a reflecting mirror 40, a light source control unit 50, a light source 60 controlled by the light source control unit 50, a sensor unit 70A, a signal conversion unit 70B, a differential processing unit 80, an extreme detection unit 90A, an extreme validity determination unit 10A, a threshold value setting unit 110A, a comparison unit 120A, and a barcode width data generation unit 130A. The extreme validity determination unit 100A includes a memory 101A, an inter-extreme time measurement unit 102A and a time comparison unit 103A.

Next, the components of the barcode reader 10A are described.

The light source control unit 50 is connected to the light source 60, and controls the generation of light. Light (for example laser beam) emitted from the light source 60 is reflected by the reflecting mirror 40 and reaches the scanning mirror 20.

The scanning mirror 20 is swung from side to side under the control of the drive control unit 20a, and applies incident light to a barcode symbol 200 as scanning light. Reflection light reflected on the barcode symbol 200 again returns to the scanning mirror 20, and is reflected by the collection mirror 30. The collection mirror 30 collects this reflection light, and applies it to a light receiving section of the sensor unit 70A. The sensor unit 70A converts the received reflection light to a current signal by photoelectric conversion in the light receiving section, and the signal conversion unit 70B converts this current signal to a voltage signal.

The signal conversion unit 70B is connected to the differential processing unit 80, and inputs the voltage signal to the differential processing unit 80. The input voltage signal is converted to a differential signal by the differential processing unit 80.

The differential processing unit 80 in the first embodiment is connected to the extreme detection unit 90A, and inputs the differential signal to the extreme detection unit 90A. This extreme detection unit 90A detects an edge of the barcode signal, that is, an extreme of the differential signal. The detected extreme has not only a voltage but also time data. That is, the voltage and time of the extreme are detected.

The extreme detection unit 90A is connected to the extreme validity determination unit 100A. This extreme validity determination unit 100A includes the memory 101A, the inter-extreme time measurement unit 102A and the time comparison unit 103A which are connected to one another.

The extreme validity determination unit 100A determines the validity of an extreme in accordance with the size of the inter-extreme time data, as described later. The extreme validity determination unit 100A is connected to the threshold value setting unit 110A. The threshold value setting unit 110A is connected to the comparison unit 120A.

The comparison unit 120A compares a threshold value with the extreme regarded as valid in the extreme validity determination unit 100A, and again determines the validity of the extreme. The comparison unit 120A is connected to the barcode width data generation unit 130A. The barcode width data generation unit 130A generates width data for a barcode on the basis of the time data for the extreme. The processing in the barcode width data generation unit 130A is hereinafter referred to as binarization processing.

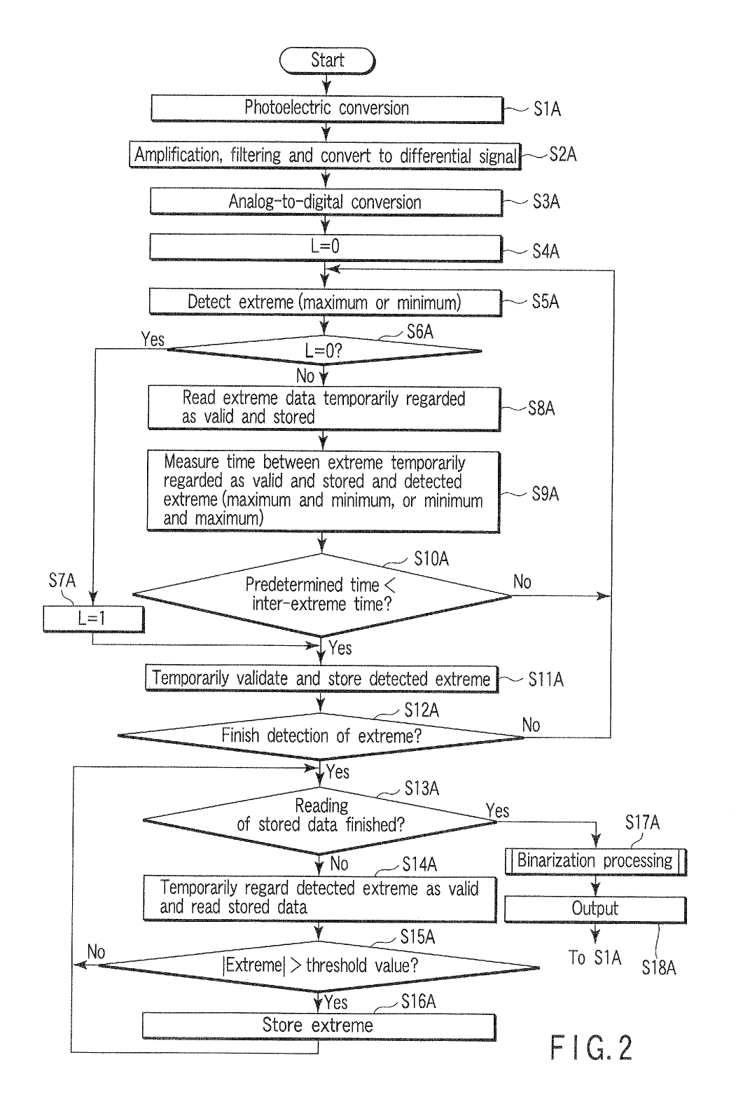

Next, the processing in the barcode reader 10A is described in detail referring to a flowchart shown in FIG. 2. FIG. 2 is flowchart showing details of the processing in the barcode reader 10A described above. This flowcharts show the operation in the barcode reader 10A shown in FIG. 1 after the sensor unit 70A has received reflection light from the collection mirror 30.

First, the signal conversion unit 70B converts a current signal generated by photoelectric conversion in the sensor unit 70A to a voltage signal (step S1A). The differential processing unit 80 amplifies the obtained voltage signal to perform differential processing and filtering, and generates a differential signal (step S2A). The extreme detection unit 90A subjects this differential signal to analog-to-digital conversion (step S3A), and converts it to digital sampling data.

Then, 0 is set to reset a flag L for determining whether an extreme has been detected (step S4A).

Furthermore, the extreme detection unit 90A detects an extreme corresponding to the edge of a barcode from the digital sampling data (step S5A). After this detection, whether the flag L is equal to 0 is determined (step S6A). When the flag L is 0, that is, when the detected extreme is the first extreme (YES), 1 is set for the flag L (step S7A). The detected extreme is temporarily regarded as valid and stored in the memory 101A of the extreme validity determination unit 100A (step S11A). The storage in this case is carried out in the form of time-lapse data so that the value of the extreme is paired with the time data. The valid extreme means that the extreme is valid as an extreme for generating the barcode width data.

Then, whether the detection of the extreme has been finished is determined (step S12A). That is, whether there is any extreme remaining in the digital sampling data is determined. When it is determined that the detection of the extreme has not been finished (NO), the flow returns to step S5A. When the detection of the extreme has not been finished and the flow returns to step S5A, an extreme is again detected by the extreme detection unit 90A as described above. On the other hand, when the detection of the extreme has been finished (YES), the flow shifts to step S13A described later.

The detection of the extreme by the extreme detection unit 90A in the first embodiment is carried out so that minimums and maximums are alternately detected. That is, as described above, if the first extreme stored in the memory 101A of the extreme validity determination unit 100A is a maximum as described above, the extreme detected here is a minimum. On the contrary, if the stored first extreme is a minimum, the extreme detected here is a maximum. The following explanation of a processing procedure is given on the assumption that an extreme which has been first regarded as valid and stored is a maximum. On the contrary, when an extreme which has been first regarded as valid and stored is a minimum, the maximum and the minimum have only to be read alternately with each other.

In step S5A, an extreme is again detected. In step S6A, whether an extreme detected last is the first extreme is determined (whether L=0 is determined). In this determination, 1 has already been set for the flag L in step S7A, so that step S5A branches to NO.

Extreme data temporarily determined to be valid and stored in the memory 101A immediately before is read (step S8A). That is, if there is no extreme which is temporarily determined to be valid and stored after the first extreme has been temporarily determined to be valid and stored, extreme data to be read is data which has been first stored in step S11A (after the branching of step S6A to YES). Thus, if there is an extreme which is newly temporarily determined to be valid and stored after the first extreme has been temporarily determined to be valid and stored, data for this extreme is read.

The inter-extreme time measurement unit 102A of the extreme validity determination unit 100A measures time between the stored and read extreme and the detected extreme (difference between the respective time data) (step S9A).

Then, the time comparison unit 103A of the extreme validity determination unit 100A compares the measured inter-extreme time with predetermined time set in advance (step S10A). This predetermined time may be an adjustable parameter. The following explanation is separated into two cases: a case where the inter-extreme time is longer than the predetermined time (YES) as a result of the comparison and a case where the inter-extreme time is equal to or less than the predetermined time (NO).

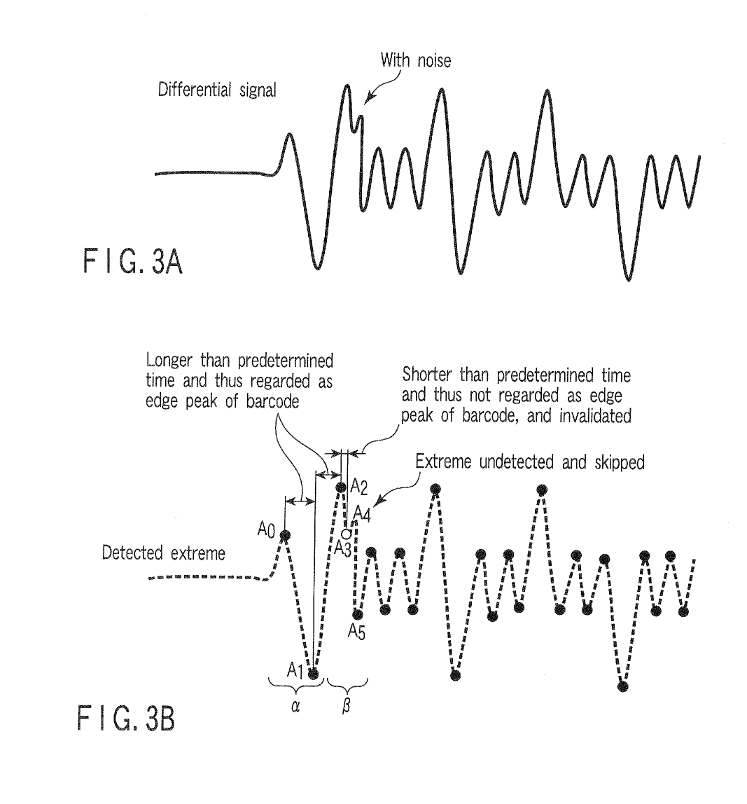

First, in the case where the inter-extreme time is longer than the predetermined time (YES), the flow again proceeds to step S11A, and the detected extreme is stored as an effected extreme. FIG. 3A shows one example of a differential signal in the first embodiment, and FIG. 3B is a diagram showing a corresponding extreme detected from the differential signal. An extreme A₀ is the first extreme (maximum), and is an extreme which has been temporarily regarded as valid and stored first as described above.

The maximum A₀ and a minimum A₁ indicated in a section α in FIG. 3B correspond to the case where the inter-extreme time is longer than the predetermined time. In this case, the minimum A₁ is temporarily regarded as valid and stored second, as described above (step S11A). Then, in the case of the signal shown in FIG. 3B, the detection of the extreme has not been finished, so that the flow returns to step S5A (step S12A branches to NO).

Then, an extreme A₂ is detected in step S5A. For this extreme A₂, step S5A to step S9A are repeatedly processed so that the measurement of the inter-extreme time starts from the extreme A₁ which has been temporarily regarded as valid and stored immediately before. As a result, in the example shown in FIGS. 3A, 3B, the extreme A₂ is also temporarily regarded as a valid extreme and stored. In this example, in the extreme temporarily regarded as valid and stored in the memory 101A of the extreme validity determination unit 100A, the maximums and the minimums alternate in such a manner as the maximum (A₀), the minimum (A₁), the maximum (A₂). Unless noise is detected, this relation is continued to store the temporarily valid extreme.

Subsequently, when the time interval between the extremes is equal to or less than the predetermined time (step S10A branches to NO), the flow determines that the newly detected extreme is noise, and does not store this extreme. In this case, the flow returns to step S5A. In FIG. 3B, when the maximum A₂ indicated in a section β is temporarily regarded as a valid extreme and stored as described above, a minimum A₃ is determined to be noise because the time interval between the maximum A₂ and the minimum A₃ is equal to or less than the predetermined time. In this case, the minimum A₃ is not stored.

Then, in step S5A, an extreme is again detected. In this case, in the signal shown in FIG. 3B, the following extreme is a maximum A₄. However, since the extreme A₂ which has been temporarily regarded as valid and stored immediately before is a maximum, the extreme detection unit 90A does not detect the maximum A₄. The reason is that, as described above, the extreme detection unit 90A in the first embodiment alternately detects the maximums and the minimums. As a result, this maximum A₄ is not detected and is skipped, and the next minimum A₅ is detected as an extreme.

Such processing is repeated, and when the detection of all the extremes has been finished, the flow branches step S12A to YES.

In the example described above, when a minimum is noise, the following maximum is not detected and is skipped, and the next minimum is detected. However, if the maximum is noise, the following minimum is not detected and is skipped, and the next maximum is detected.

Then, whether the extremes temporarily regarded as valid and stored have been all read is determined (step S13A). When it is determined that all the extremes have been read, the binarization processing is performed as described later. When it is determined that all the extremes have not been read yet, one extreme which has been temporarily regarded as valid and stored in the memory 101A of the extreme validity determination unit 100A in the above-mentioned step S11A is read (step S14A).

The threshold value setting unit 110A has a threshold value for determining the validity of the read extreme. The comparison unit 120A determines whether the absolute value of this read extreme is more than the predetermined threshold value (step S15A). When the absolute value of the extreme is equal to or less than the predetermined threshold value (NO), this extreme is determined to be noise. As a result of the determination, this extreme does not serve as a valid extreme for generating the barcode width data. After this determination, the flow returns to step S13A.

On the other hand, when it is determined in step S15A that the absolute value of the extreme is more than the threshold value (YES), this extreme is regarded as a valid extreme for use in the generation of the barcode width data, and stored in the comparison unit 120A (step S16A). Then, the flow returns to step S13A.

When it is determined in step S13A that all the stored data have been read (YES), the binarization processing is then performed (step S17A), and the series of processing is finished. The barcode width data generation unit 130A performs the binarization processing using the time data for the extremes stored in the comparison unit 120A as the valid extremes.

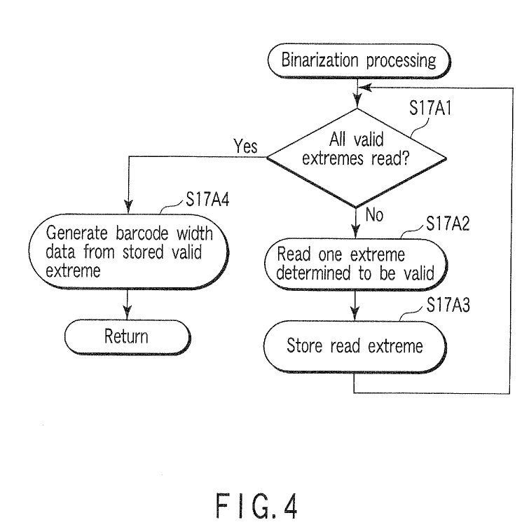

A flowchart shown in FIG. 4 is a subroutine of the binarization processing.

First, it is determined whether all the valid extremes stored in the comparison unit 120A have been read in the barcode width data generation unit 130A (step S17A1). If it is determined that all the extremes have not been read (NO), one extreme determined to be valid is read from the comparison unit 120A (step S17A2), and the read extreme is stored in the barcode width data generation unit 130A (step S17A3). Such processing is repeated, and if it is determined in step S17A1 that all the stored data have been read (YES), barcode width data is generated on the basis of the stored extreme (step S17A4).

The result of this binarization processing is output to a decoder (not shown) connected to this barcode reader 10A (step S18A). Unless a processing stopping instruction based on the output result comes from the decoder, the barcode reader 10A returns to the flow in FIG. 2 to repeat the processing described above, and resumes the acquisition of low data for photoelectric conversion (step S1A).

As described above, according to the first embodiment, a time difference between the extremes is measured to identify noise, and the extreme determined to be noise is not stored, such that necessary storage capacity of a memory can be lower than in a processing method which temporarily stores all extreme data including noise. Moreover, especially when much noise is generated, the detected noise is not used in the binarization processing, such that the time necessary for the binarization processing and load on the apparatus are reduced.

### Second Embodiment

A second embodiment of the present invention is described next.

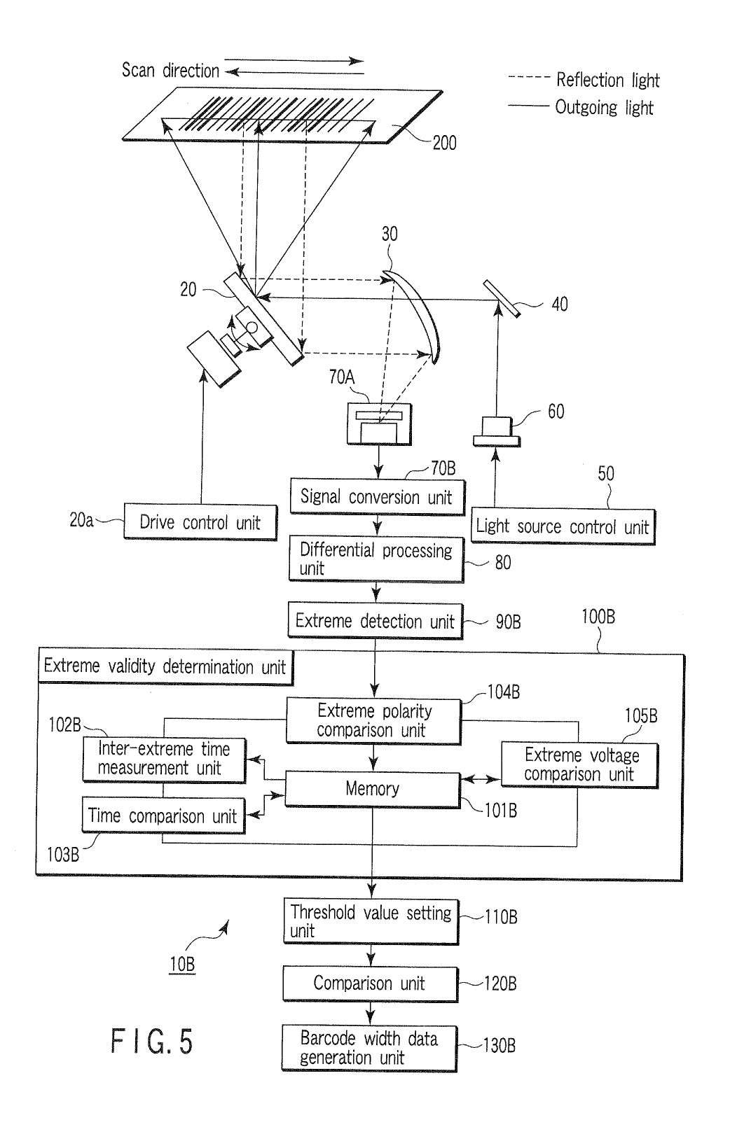

FIG. 5 is a block diagram schematically showing the configuration of a barcode reader 10B according to the second embodiment. The same reference signs are assigned to components in the present embodiment equivalent to the components in the first embodiment previously described, and such components are not described in detail.

This barcode reader 10B comprises a drive control unit 20a, a scanning mirror 20 controlled by the drive control unit, a collection mirror 30, a reflecting mirror 40, a light source control unit 50, a light source 60 controlled by the light source control unit 50, a sensor unit 70A, a signal conversion unit 70B, a differential processing unit 80, an extreme detection unit 90B, an extreme validity determination unit 100B, a threshold value setting unit 110B, a comparison unit 120B, and a barcode width data generation unit 130B. The extreme validity determination unit 100B includes a memory 101B, an inter-extreme time measurement unit 102B, a time comparison unit 103B, an extreme polarity comparison unit 104B and an extreme voltage comparison unit 105B.

The operations of these components are described below.

However, the operations of the drive control unit 20a, the scanning mirror 20, the collection mirror 30, the reflecting mirror 40, the light source control unit 50, the light source 60, the sensor unit 70A, the signal conversion unit 70B and the differential processing unit 80 are similar to those in the first embodiment and are therefore briefly explained.

A current signal generated from reflection light by the sensor unit 70A is converted to a voltage signal by the subsequently connected signal conversion unit 70B. This voltage signal is input to the differential processing unit 80 and converted to a differential signal.

The differential processing unit 80 is connected to the extreme detection unit 90B, and inputs the differential signal to the extreme detection unit 90B. The extreme detection unit 90B detects an edge of a barcode signal, that is, an extreme of the differential signal. In addition, the detected extreme has not only a voltage but also time data. That is, the voltage and time of the extreme are detected.

The extreme detection unit 90B is connected to the extreme validity determination unit 100B. The extreme validity determination unit 100B includes the memory 101B, the inter-extreme time measurement unit 102B, the time comparison unit 103B, the extreme polarity comparison unit 104B and the extreme voltage comparison unit 105B which are connected to one another.

The extreme validity determination unit 100B not only depends on the size of inter-extreme time data but also compares voltages between two extremes with the same polarity, as described below. As a result of this comparison, only one of the extremes considered to be noise is invalidated, such that whether the extreme is valid is determined. Here, the “polarity” means a distinction between the maximum and the minimum. For example, two maximums are extremes having the same polarity. Two minimums are also extremes having the same polarity. On the contrary, one maximum and one minimum are extremes having different polarities.

The extreme validity determination unit 100B is connected to the threshold value setting unit 110B. The threshold value setting unit 110B is connected to the comparison unit 120B. The comparison unit 120B compares a threshold value with the extreme regarded as valid in the extreme validity determination unit 100B, and again determines the validity of the extreme. The comparison unit 120B is connected to the barcode width data generation unit 130B.

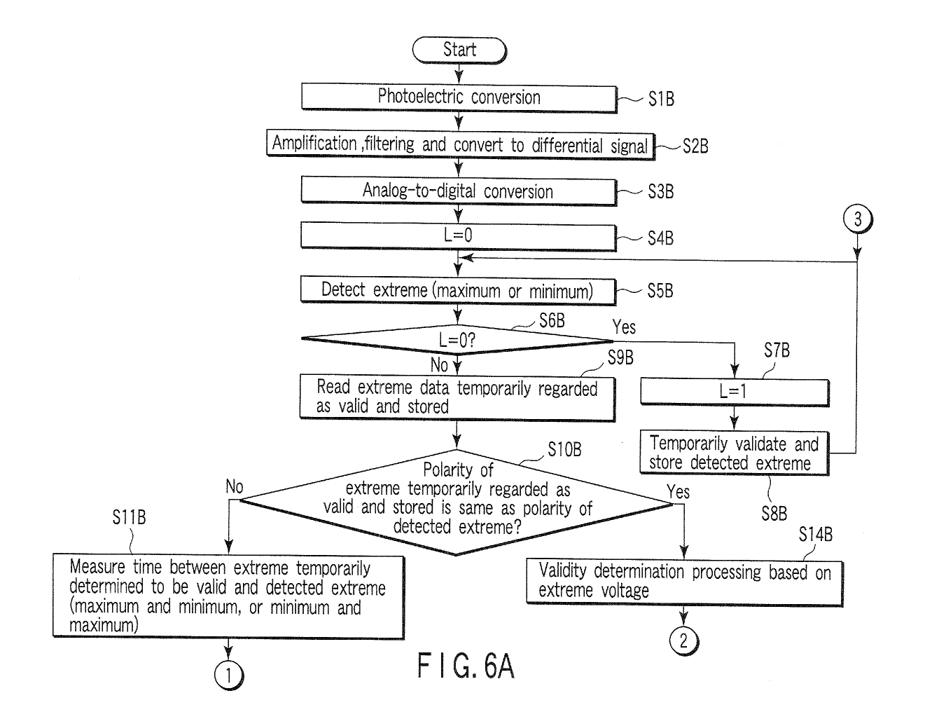

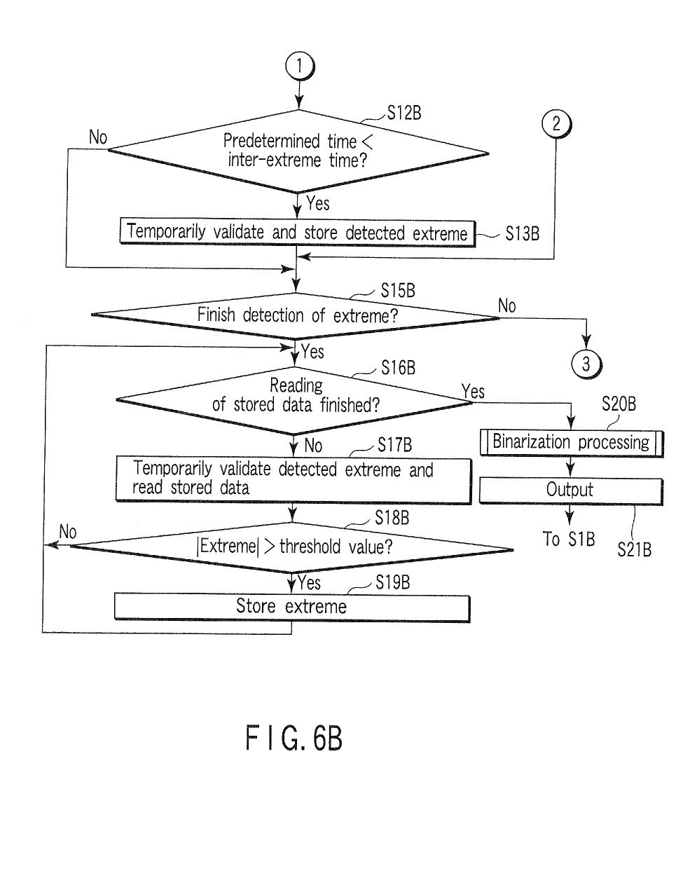

FIGS. 6A, 6B are flowcharts showing details of the processing in the barcode reader 10B described above. These flowcharts show the operation in the barcode reader 10B shown in FIG. 5 after the sensor unit 70A has received reflection light from the collection mirror 30.

First, the sensor unit 70A generates a current signal by photoelectric conversion from the received reflection signal, and the current signal is converted to a voltage signal by the signal conversion unit 70B (step S1B). The differential processing unit 80 subjects the voltage signal to differential processing and filtering to generate a differential signal (step S2B). The extreme detection unit 90B subjects this differential signal to analog-to-digital conversion (step S3B), and converts it to digital sampling data.

Then, 0 is set to reset a flag L for determining whether an extreme has been detected (step S4B).

Furthermore, the extreme detection unit 90B detects an extreme corresponding to the edge of a barcode from the digital sampling data (step S5B). After this detection, whether the flag L is equal to 0 is determined (step S6B). When the flag L is 0 (YES), that is, when the detected extreme is the first extreme, 1 is then set for the flag L (step S7B). The detected extreme is temporarily regarded as valid and stored in the memory 101B of the extreme validity determination unit 100B (step S8B). The storage in this case is carried out in the form of time-lapse data so that the value of the extreme is paired with the time data.

After this storage, the flow returns to step S5B, and a new extreme is again detected. Unlike the extreme detection unit 90A in the first embodiment, the extreme detection unit 90B in the second embodiment does not necessarily detect the extreme so that the minimums and the maximums are alternately detected. That is, even if the first extreme stored in the memory 101B of the extreme validity determination unit 100B is a maximum as described above, the extreme detected here is a minimum or a maximum (the extreme is detected regardless of the “polarities” of the extremes described above).

In step S6B that follows, the flag L is equal to 1 until this flow performs the final processing, so that step S6B always branches to NO.

Then, data for an extreme stored last is read from the memory 101B for the comparison between the newly detected extreme and the extreme stored last (step S9B). If no extreme temporarily regarded as valid and stored is newly detected after the first extreme has been temporarily determined to be valid and stored, the extreme data read here is the data which has been stored first in step S8B (after step S6B has branched to YES). Therefore, if there is newly any extreme temporarily regarded as valid and stored after the first extreme has been temporarily determined to be valid and stored, such an extreme is read.

The extreme polarity comparison unit 104B determines the polarity of this read extreme and the polarity of the extreme detected in step S5B which has most recently been executed (step S10B). If it is determined that the two extremes have the same polarity (YES), the flow shifts to validity determination processing based on an extreme voltage in step S14B described later.

The case where it is determined in step S10B that the two extremes have different polarities (NO) is described. The processing when the two extremes have different polarities is similar to the processing in the first embodiment. The inter-extreme time measurement unit 102B of the extreme validity determination unit 100B measures the time between the stored and read extreme and the detected extreme (a difference between their time data) (step S11B). Then, the time comparison unit 103B of the extreme validity determination unit 100B compares the measured inter-extreme time with predetermined time set in advance (step S12B). This predetermined time may be an adjustable parameter.

As a result of the comparison in step S12B, if the inter-extreme time is longer than the predetermined time (YES), the newly detected extreme is temporarily regarded as valid and stored in the memory 101B of the extreme validity determination unit 100B (step S13B).

Then, whether the detection of the extreme has been finished is determined (step S15B). When it is determined that the detection of the extreme has been finished (YES), the flow shifts to step S16B described later. On the other hand, when the detection of the extreme has not been finished yet (NO), the flow returns to step S5B. In this case, when the flow returns to step S5B, an extreme is newly detected. However, as described above, the detection of the extreme in the second embodiment is carried out regardless of the polarity, so that the extreme detection unit 90B detects the extremes without skips.

Moreover, when the inter-extreme time is equal to or less than the predetermined time in the comparison in step S12B (NO), the newly detected extreme is not stored in the memory, and the flow shifts to step S15B.

Subsequently, when it is determined in step S10B that the extreme temporarily regarded as valid and stored and the newly detected extreme have the same polarity (YES), the flow shifts to the validity determination processing based on the extreme voltage in step S14B described later. The validity determination processing based on the extreme voltage is described here.

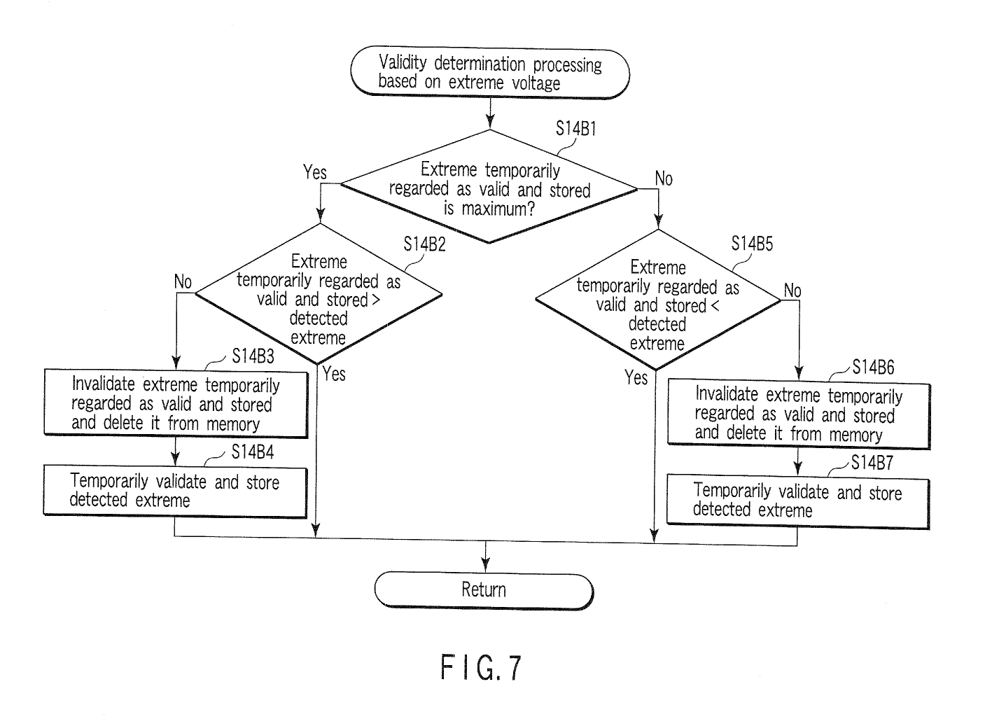

A flowchart shown in FIG. 7 is a subroutine for explaining the validity determination processing based on the extreme voltage.

First, whether the extreme temporarily regarded as valid and stored is a maximum is determined (step S14B1). The validity is determined by the extreme voltage only when the two extremes to be compared have the same polarity. Thus, whether these two extremes are maximums is determined (step S14B1). When it is determined that these two extremes are maximums (YES), it is then determined whether the extreme which has been temporarily regarded as valid and stored and then read for comparison is higher than the detected extreme (step S14B2). On the other hand, when these two extremes are not maximums, that is, minimums (NO), the flow shifts to step S14B5.

The determination in step S14B2 is made by the extreme voltage comparison unit 105B of the extreme validity determination unit 100B. When the extreme stored in the memory is higher than the detected extreme (YES), the stored extreme is left as it is, and the newly detected extreme is destroyed without being stored in the memory, and then the flow returns to the main flow shown in FIG. 6. On the other hand, when the extreme temporarily regarded as valid and stored is lower than the detected extreme (NO), the extreme temporarily regarded as valid and stored is invalidated and deleted from the memory 101B (step S14B3), and the newly detected extreme is temporarily regarded as valid and stored in the memory (step S14B4), and then the flow returns to the main flow shown in FIG. 6.

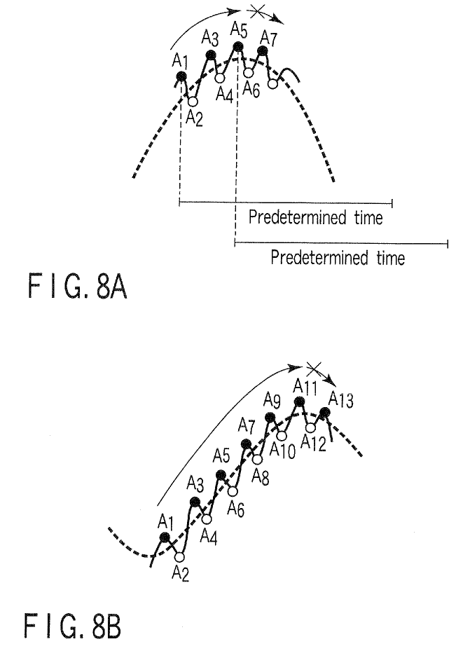

Furthermore, FIGS. 8A, 8B show one example of the validity determination processing based on the extreme voltage.

FIGS. 8A, 8B both show the case where two extremes are maximums as described above. FIG. 8A is a diagram for explaining the validity determination processing for a plurality of extreme voltages generated in the vicinity of an area which is originally used as the peak of a maximum in binarization processing. On the other hand, FIG. 8B is a diagram for explaining the validity determination processing for a plurality of extreme voltages generated in the vicinity of an area which is likewise used as the peak of a maximum in binarization processing.

As shown in FIG. 8A, the predetermined time in step S12B in FIG. 6 is less than the scale of the time interval between these barcode original peak and bottom for the simplification of a determination, but is set up more greatly than the time interval of the peak and bottom of a noise signal. Thus, even if the flow branches to NO in determinations up to step S10B in FIG. 6, an extreme having a different polarity (meaning a minimum in this case) is not temporarily regarded as a valid extreme and stored in step S13B. Therefore, FIG. 8A is described below in connection with the processing from step S14B1 to step S14B3 alone.

In FIG. 8A, an extreme A₁ first stored is lower than a detected extreme A₃. However, as described above, a minimum A₂, A₄, A₆ is not stored even if detected because the time interval between this extreme and the maximum immediately before is less than the predetermined time. Thus, the minimums A₂, A₄, A₆ are not described below.

Here, the highest maximum is an extreme A₅. Under such circumstances, the determination in step S14B2 branches to NO. As a result, the extreme A₁ is deleted from the memory 101B, and the extreme A₃ is newly temporarily regarded as a valid extreme and stored in the memory 101B. (The starting point for comparing the time interval between the extreme A₃ and the extreme A₄ moves to the time data for the extreme A₃. The same holds true with the following cases.)

Since the voltage of the extreme A₃ is lower than the voltage of the extreme A₅, the extreme A₃ is likewise deleted from the memory 101B, and data for the extreme A₅ is newly stored. Then, if the voltage of the extreme A₅ is compared with the voltage of an extreme A₇, the voltage of the extreme A₅ is higher, so that a sub-flowchart shown in FIG. 7 branches to YES in step S14B2 for the first time. After all, the extreme A₅ is validated as a maximum, and steps S11B to S13B in the main flow are then repeated to search for a valid extreme (maximum).

In FIG. 8B, the extreme A₁ stored first is located in the vicinity of the bottom, and the maximum then rises from the extreme A₂ to an extreme A₁₂ and turns into a fall at an minimum A₁₃. Although explanation is the same as in FIG. 8A and is not given, the extreme to be stored changes from A₁ to A₁₁, and the previous maximums A₁ to A₉ are not stored in the memory 101B. After all, in this case as well, the search for a maximum moves near the peak, and the fall is stopped. Subsequently, steps S11B to S13B in the main flow are then repeated to search for a valid extreme (maximum).

When the flow moves from step S14B5 to step S14B7 in the flowchart shown in FIG. 7, its attention is paid to the comparison between the minimums. That is, as the movement of the maximum described referring to FIG. 8, the minimum moves such that the most suitable position (in the vicinity of the bottom) is searched for. This process is similar to the validity determination processing using the maximum, and is not described.

In FIG. 7, for the voltage serving as a reference in the comparison between the voltages of the extremes, a preset reference voltage may be used, or an extreme detected before the extreme whose validity is to be determined may be used. Then, when it is determined in step S15B in FIG. 16 that the detection of the extreme has been finished (YES), it is determined whether the reading of the data temporarily regarded as valid and stored has been finished (step S16B). When it is determined that the reading has been finished (YES), the flow shifts to the binarization processing described later. On the other hand, when the reading of the data has not been finished yet (NO), data which has not been read yet and which has been temporarily regarded as valid and stored is read (step S17B).

The threshold value setting unit 110B has a threshold value for determining the validity of the read extreme.

The comparison unit 120B determines whether the absolute value of this read extreme is more than the predetermined threshold value (step S18B). When the absolute value of the extreme is equal to or less than the predetermined threshold value (NO), this extreme is determined to be noise, and the flow returns to step S16B. In accordance with this determination, this extreme does not serve as a valid extreme for generating barcode width data. On the other hand, when it is determined that the absolute value of the extreme is more than the threshold value (YES), that is, when it is determined that this extreme is a valid extreme for use in the generation of the barcode width data, the extreme is stored in the comparison unit 120B (step S19B), and the flow returns to step S16B.

Then, when it is determined in step S16B that all the stored data have been read (YES), the binarization processing is performed (step S20B). The barcode width data generation unit 130B performs the binarization processing using the time data for the extreme stored in the comparison unit 120B as a valid extreme. This binarization processing is similar to the binarization processing in the first embodiment described referring to FIG. 4, and is therefore not described here.

The result of this binarization processing is output to a decoder (not shown) connected to this barcode reader 10B (step S21B). Unless a processing stopping instruction based on the output result comes from the decoder, the barcode reader 10B returns to the photoelectric conversion to repeat the processing described above, and resumes the acquisition of low data (step S1B).

As described above, the second embodiment not only depends on the size of inter-extreme time data but also compares voltages of two extremes with the same polarity in the determination of the validity of the extreme, in addition to the processing in the first embodiment.

### Third Embodiment

A third embodiment of the present invention is described next.

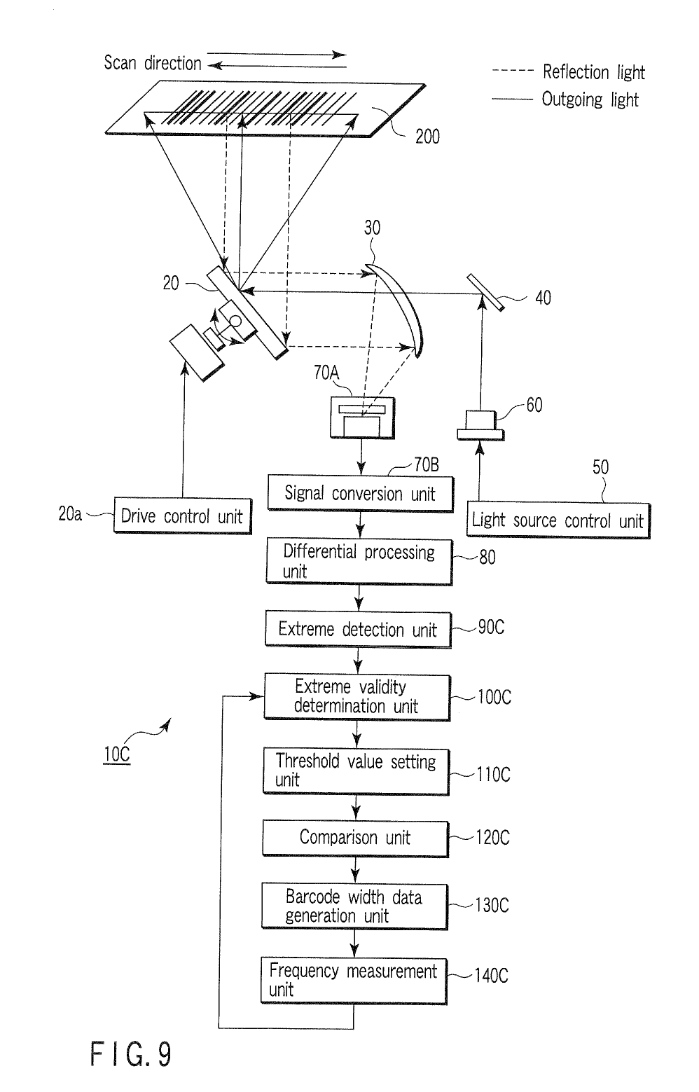

FIG. 9 is a block diagram schematically showing the configuration of a barcode reader 10C according to the third embodiment.

This barcode reader 10C comprises a drive control unit 20a, a scanning mirror 20 controlled by the drive control unit, a collection mirror 30, a reflecting mirror 40, a light source control unit 50, a light source 60 controlled by the light source control unit 50, a sensor unit 70A, a signal conversion unit 70B, a differential processing unit 80, an extreme detection unit 90C, an extreme validity determination unit 100C, a threshold value setting unit 110C, a comparison unit 120C, a barcode width data generation unit 130C and a frequency measurement unit 140C.

The extreme validity determination unit 100C may have the same configuration as the extreme validity determination unit 100A in the first embodiment or the same configuration as the extreme validity determination unit 100B in the second embodiment. In this case, the extreme detection method in the extreme detection unit 90C has to be changed depending on which of the configurations to be employed. That is, the determination unit has to select and determine whether to detect an extreme having the same polarity as the extreme temporarily regarded as valid and stored or to only detect an extreme having a different polarity.

The following explanation assumes that the extreme validity determination unit 100C is equal to the extreme validity determination unit 100A in the first embodiment. Therefore, the extreme validity determination unit 100C includes a memory 101C, an inter-extreme time measurement unit 102C and a time comparison unit 103C. However, the configuration and operation of the extreme validity determination unit 100C can be also equal to those in the second embodiment.

On the other hand, when the extreme validity determination unit 100C has a configuration similar to the configuration of the extreme validity determination unit 100B in the second embodiment, the extreme validity determination unit 100C further includes an extreme polarity comparison unit 104C and an extreme voltage comparison unit 105C.

Next, the operations of the components in the present embodiment are described.

The operations of the drive control unit 20a, the scanning mirror 20, the collection mirror 30, the reflecting mirror 40, the light source control unit 50, the light source 60, the sensor unit 70A, the signal conversion unit 70B and the differential processing unit 80 in the present embodiment are similar to those in the first embodiment and are briefly explained.

A current signal generated from reflection light by the sensor unit 70A is converted to a voltage signal by the subsequently connected signal conversion unit 70B. This voltage signal is input to the differential processing unit 80 and converted to a differential signal.

The differential processing unit 80 inputs the differential signal to the extreme detection unit 90C connected thereto. The extreme detection unit 90C detects an edge of a barcode signal, that is, an extreme of the differential signal. The detected extreme has not only a voltage value but also time data. That is, the voltage value and time of the extreme are detected.

The extreme detection unit 90C is connected to the extreme validity determination unit 100C. Here, the configuration of the extreme validity determination unit 100C is similar to that in the first embodiment, as described above. The extreme validity determination unit 100C is connected to the threshold value setting unit 110C. The threshold value setting unit 110C is connected to the comparison unit 120C. The comparison unit 120C compares a threshold value with the extreme regarded as valid in the extreme validity determination unit 100C, and again determines the validity of the extreme. The comparison unit 120C is connected to the barcode width data generation unit 130C.

In the third embodiment, the frequency measurement unit 140C is connected to the barcode width data generation unit 130C. The output of the frequency measurement unit 140C is output to the extreme validity determination unit 100C.

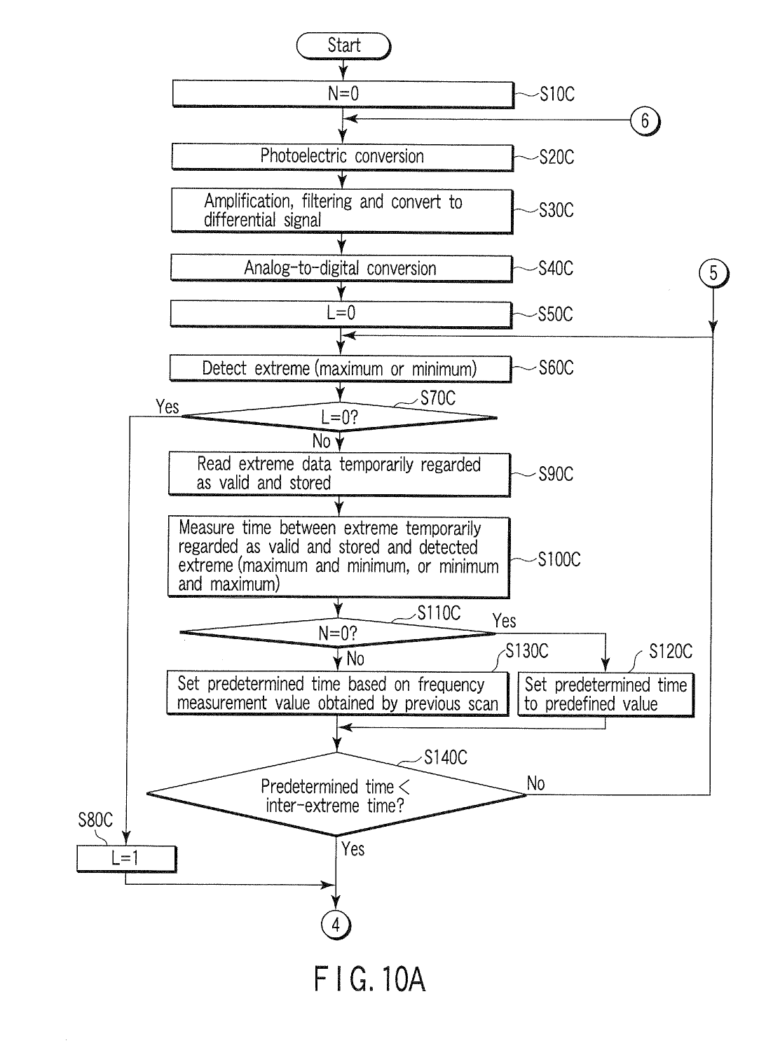

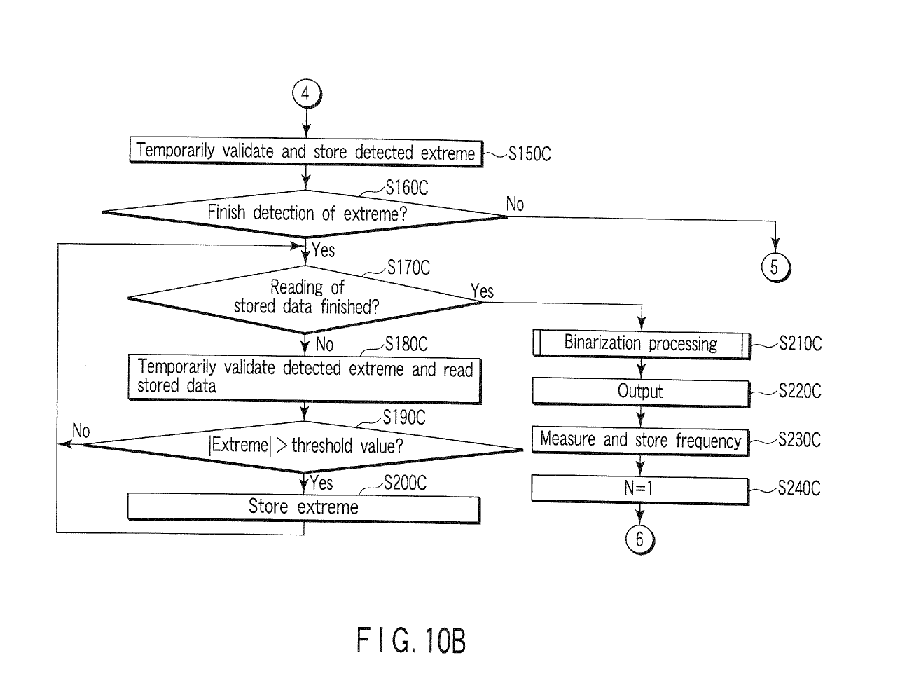

The processing in the barcode reader 10C is described referring to flowcharts shown in FIGS. 10A, 10B. FIGS. 10A and 10B are flowchart showing details of the processing in the barcode reader 10C described above. These flowcharts show the operation in the barcode reader 10C shown in FIG. 9 after the sensor unit 70A has received reflection light from the collection mirror 30.

First, the barcode reader 10C performs initialization by setting 0 to a flag N indicating that binarization processing has never been performed (step S10C). In step S10C, the initialization is not performed again even if the barcode reader repeats reading operation.

The current signal generated by photoelectric conversion from the reflection light received in the sensor unit 70A is converted to a voltage signal (step S20C). The differential processing unit 80 subjects the voltage signal to differential processing and filtering and converts it to a differential signal (step S30C). The extreme detection unit 90C subjects this differential signal to analog-to-digital conversion (step S40C), and converts it to digital sampling data.

Then, 0 is set to reset a flag L indicating that an extreme has already been detected (step S50C). The extreme detection unit 90C detects an extreme corresponding to the edge of a barcode from the digital sampling data (step S60C).

Then, whether the value of the flag L is 0 is determined (step S70C). When it is determined that the flag L is 0 (YES), this means an extreme detected first, and 1 is set for the flag L (step S80C). The detected extreme is temporarily regarded as valid and stored in the memory 101C of the extreme validity determination unit 100C (step S150C). The storage here is carried out in the form of time-lapse data so that the value of the extreme is paired with the time data.

When it is determined in step S70C that the flag L is not equal to 0 (NO), data for the extreme stored last in the memory 101C is read in order to newly detect an extreme (step S90C).

The detection of the extreme by the extreme detection unit 90C in the third embodiment assumes that minimums and maximums are alternately detected, as in the first embodiment. Step S70C that follows always branches to NO (due to L=1) until this flow performs the final processing.

In this step S90C, the data for the extreme read from the memory 101C is compared with the newly detected extreme. At this moment, if there is no extreme which is newly temporarily regarded as valid and stored after the first extreme has been temporarily determined to be valid and stored, extreme data read here is data which has been first stored in step S150C (after the branching of step S70C to YES). On the other hand, if there is an extreme which is newly temporarily regarded as valid and stored after the first extreme has been temporarily determined to be valid and stored, data for this extreme is read.

The inter-extreme time measurement unit 102C of the extreme validity determination unit 100C measures time between the extreme read from the memory 101C and the detected inter-extreme (difference between the respective time data) (step S100C).

Then, whether the flag N=0 set at the initialization is maintained is determined (step S110C). This means determining whether the barcode reader 10C has already performed the binarization processing. As described later, if the binarization processing is performed even once (NO), the value of the flag N is rewritten (step S130C) as “1”. In this case (in the case of “NO”), the flow advances to step S130C. In step S130C, a time calculated based on the frequency measured and stored in step S230C is set as predetermined time.

On the other hand, if the flag N is equal to 0 (YES), the binarization processing has not been performed yet. In this case, predetermined time to be compared with the inter-extreme time interval is set to a predefined value (step S120C). The predefined value is stored in the memory 101C of the extreme validity determination unit 100C, and may be read therefrom. Moreover, this value may be adjustable.

Then, the time comparison unit 103C of the extreme validity determination unit 100C compares the measured inter-extreme time with predetermined time (step S140C). If the inter-extreme time is longer than the predetermined time in this comparison (YES), the flow shifts to step S150C, and the detected extreme is regarded as a valid extreme and stored. Then, whether the detection of the extreme has been finished is determined (step S160C). When the detection has not been finished yet (NO), the flow returns to step S60C, and an extreme is again detected. Moreover, if the inter-extreme time interval is less than the predetermined time in the comparison in step S140C (NO), the newly detected extreme is determined to be noise. This extreme is not stored, and the flow returns to step S60C, and then an extreme is again detected.

Such processing is repeated, and when it is determined in step S160C that the detection of all the extremes has been finished (YES), it is then determined whether all the extremes temporarily regarded as valid and stored have been read (step S170C).

When it is determined that all the extremes have been read (YES), the binarization processing is performed as described later. On the other hand, when it is determined that all the extremes have not been read (NO), one extreme temporarily regarded as valid and stored in the memory 101C of the extreme validity determination unit 100C in the above-mentioned step S90C is read (step S180C). The threshold value setting unit 110C has a threshold value for determining the validity of the read extreme.

Then, the comparison unit 120C determines whether the absolute value of this read extreme is more than the predetermined threshold value (step S190C). When the absolute value of the extreme is equal to or less than the predetermined threshold value (NO), this extreme is determined to be noise, and does not serve as a valid extreme for generating the barcode width data. After this determination, the flow returns to step S170C.

On the other hand, when it is determined in step S190C that the absolute value of the extreme is more than the threshold value (YES), this extreme is determined to be a valid extreme for use in the generation of the barcode width data, and stored in the comparison unit 120C (step S200C). After the storage, the flow returns to step S170C.

When it is determined in step S170C that all the stored data have been read (YES), the binarization processing is then performed (step S210C). The barcode width data generation unit 130C performs the binarization processing using the time data for the extreme regarded as a valid extreme and stored in the comparison unit 120C. This binarization processing has been explained referring to FIG. 4 in connection with the first embodiment, and is therefore not described here.

The result of this binarization processing is output to a decoder (not shown) connected to this barcode reader 10C (step S220C). At the same time, this output result is also input to the frequency measurement unit 140C, and the frequency measurement unit 140C measures a frequency from the signal derived from the binarization processing and stores the result (step S230C).

A value 1 is substituted for the flag N indicating that the binarization processing has been performed (step S240C). Unless a processing stopping instruction based on the output result comes from the decoder, the barcode reader 10C returns to the photoelectric conversion to repeat the processing described above, and resumes the acquisition of low data (step S20A).

In the present embodiment, if the binarization processing is performed even once, 1 is set for the flag N, and the above-mentioned step S110C always branches to NO. Then, the predetermined time is calculated and found from the frequency measured and stored in the above-mentioned step S230C (step S130C). This calculation may be performed by the frequency measurement unit 140C, or may be performed by the time comparison unit 103C of the extreme validity determination unit 100C to which the stored frequency has been input from the frequency measurement unit 140C. One conceivable way to find the predetermined time is to use one or more of a minimum value, maximum value or average of reciprocal numbers of the frequency and multiply this value by a coefficient.

As apparent from the above description, in the third embodiment, once the binarization processing is performed, the predetermined time to be compared with the inter-extreme time is found by the result of the measurement in the frequency measurement unit 140C based on the output result of the preceding binarization processing.

### Fourth Embodiment

A fourth embodiment of the present invention is described next.

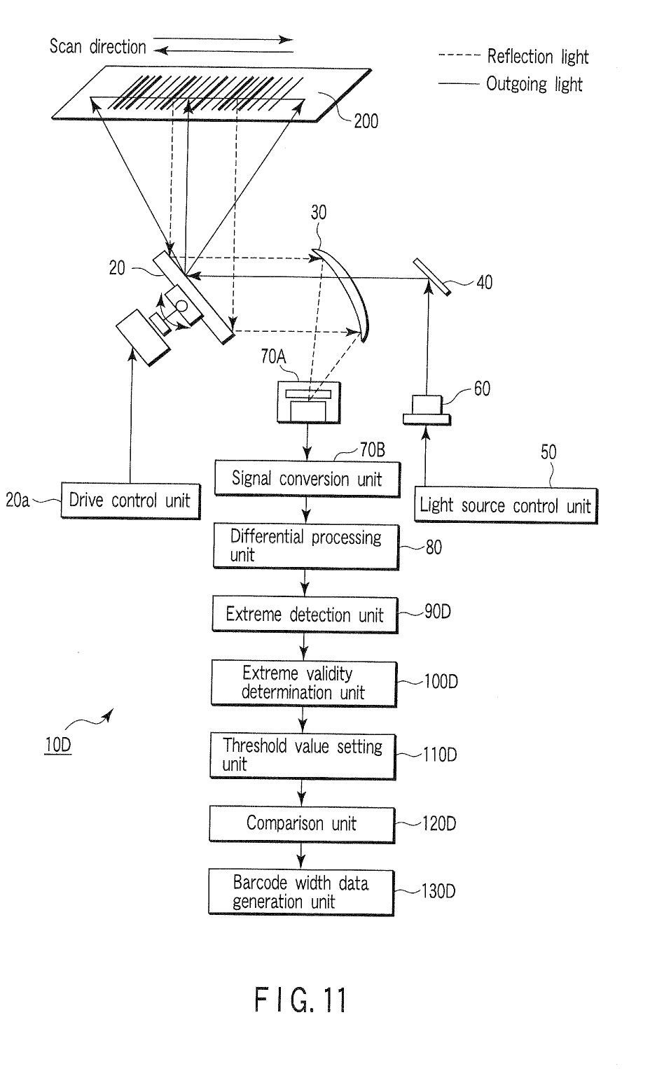

FIG. 11 is a block diagram schematically showing the configuration of a barcode reader 10D according to the fourth embodiment.

This barcode reader 10D comprises a drive control unit 20a, a scanning mirror 20 controlled by the drive control unit, a collection mirror 30, a reflecting mirror 40, a light source control unit 50, a light source 60 controlled by the light source control unit 50, a sensor unit 70A, a signal conversion unit 70B, a differential processing unit 80, an extreme detection unit 90D, an extreme validity determination unit 100D, a threshold value setting unit 110D, a comparison unit 120D and a barcode width data generation unit 130D.

The extreme validity determination unit 100D may have the same configuration as the extreme validity determination unit 100A in the first embodiment or the same configuration as the extreme validity determination unit 100B in the second embodiment. That is, when the extreme validity determination unit 100D has the same configuration as the extreme validity determination unit 100A in the first embodiment, the extreme validity determination unit 100D includes a memory 101D, an extreme time measurement unit 102D and a time comparison unit 103D. When the extreme validity determination unit 100D has the same configuration as the extreme validity determination unit 100B in the second embodiment, the extreme validity determination unit 100D further includes an extreme polarity comparison unit 104D and an extreme voltage comparison unit 105D. A voltage of an extreme and sampling data for the extreme are stored in this order in the memory 101D in the fourth embodiment.

The extreme detection method in the extreme detection unit 90D has to be changed depending on which of the configurations to be employed. That is, it is necessary to determine whether to detect an extreme having the same polarity as the extreme temporarily regarded as valid and stored or to only detect an extreme having a different polarity.

The following explanation assumes that the configuration of the extreme validity determination unit 100D is equal to the configuration in the first embodiment. However, the configuration and operation of the extreme validity determination unit 100D can be also equal to those in the second embodiment.

Furthermore, the extreme time measurement unit 102D and the time comparison unit 103D of the extreme validity determination unit 100D in the fourth embodiment operate not in accordance with the time interval between two extremes to be compared but in accordance with the number of sampling data between these extremes, in contrast with the first and second embodiments. Specifically, the extreme time measurement unit 102D detects the number of sampling data between two extremes to be compared, and the time comparison unit 103D compares this detected number of sampling data with a predetermined number of data. The sampling rate for the analog-to-digital conversion of a differential signal by the differential processing unit 80 is constant during at least one scan, so that the comparison based on the number of sampling data is equal to the comparison based on the inter-extreme time.

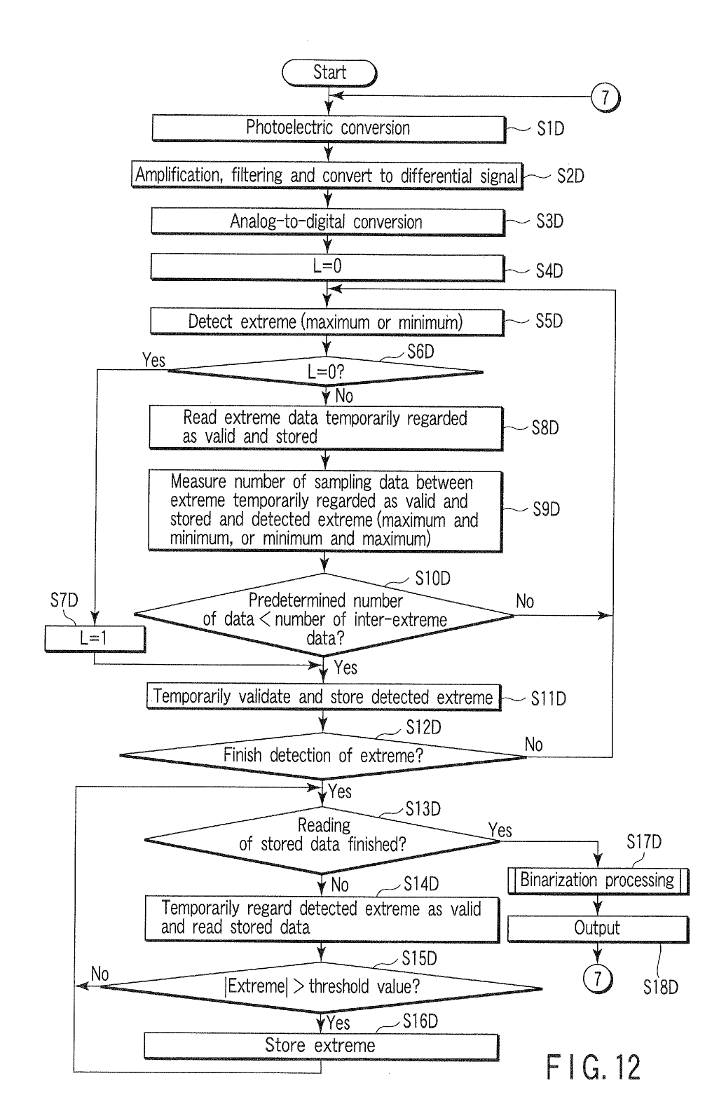

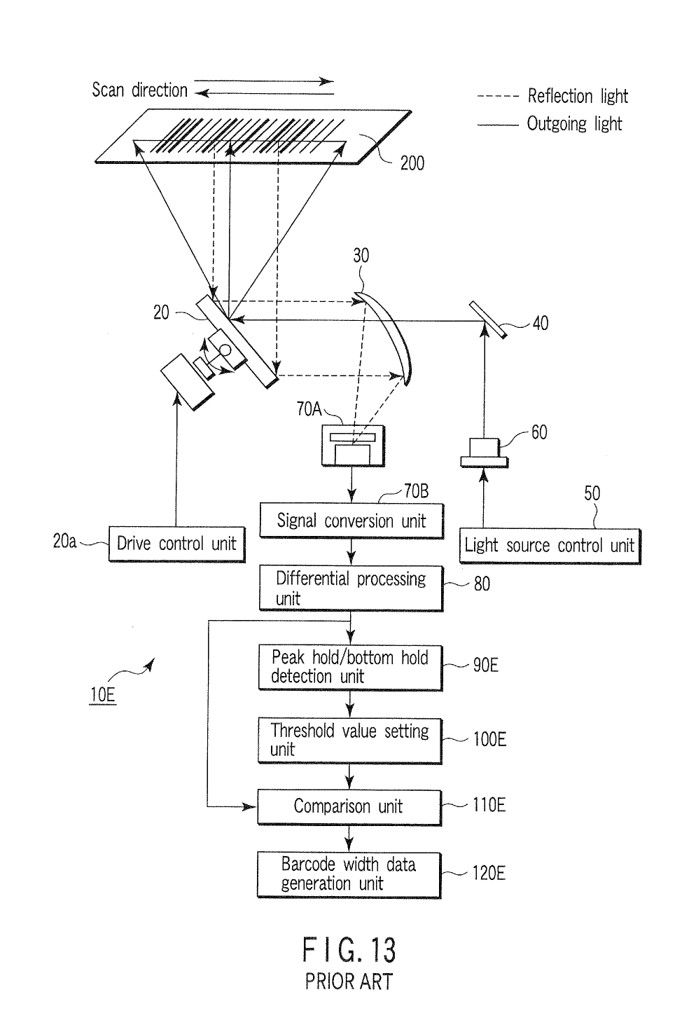

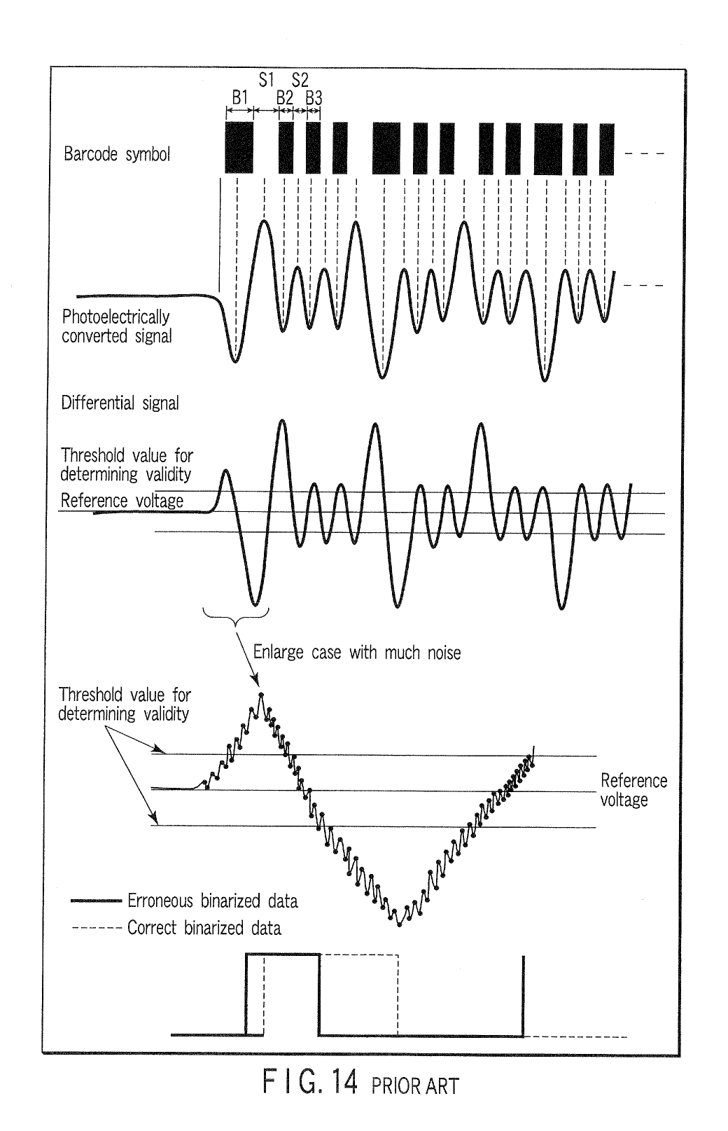

The processing in the barcode reader 10D is described referring to a flowchart shown in FIG. 12. This flowchart shows the operation in the barcode reader 10d shown in FIG. 11 after the sensor unit 70A has received reflection light from the collection mirror 30.

In this case, the flow in the fourth embodiment is equal to the flow in the first embodiment shown in FIG. 2 except for steps S9D, S10D.

When the extreme validity determination unit 100D has the same configuration as the configuration in the second embodiment, the flow in the fourth embodiment is similar to the flow in the second embodiment shown in FIG. 6 except for steps S110B, S120B. Therefore, the flowchart in FIG. 12 is not described in detail.

In addition, as in the third embodiment, it is possible to further provide a configuration for measuring the frequency of a signal used in binarization processing, so that predetermined time used to be compared with the inter-extreme time is found from the result of the measurement, and this time is divided by the sampling rate and converted into a predetermined number of data. Thus, the fourth embodiment can be suitably changed and also applied to the third embodiment.

The barcode readers in the respective embodiments have been described above. While the validity of the extreme is determined after the measurement of the inter-extreme time or the measurement of the number of sampling data in these embodiments, an embodiment is conceivable wherein the detection of an extreme is not performed until the predetermined time or the predetermined number of sampling data is reached after the extreme has been determined to be valid immediately before.

According to the embodiments of the present invention, it is possible to save the storage capacity of a memory for storing extremes. Moreover, it is possible to reduce the time necessary for the binarization processing and load on the barcode reader.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A barcode reader comprising:
a light source;
a light scanning section which scans a barcode symbol with light generated from the light source;
a light collecting section which collects reflection light reflected by the barcode symbol;
a sensor section which converts a light signal collected in the light collecting section to an electric signal;
a differential processing section which generates a differential signal from the electric signal generated by the sensor section;
an extreme detection section which detects an extreme of the differential signal generated by the differential processing section;
an extreme validity determination section which determines whether the extreme detected by the extreme detection section is a valid extreme;
a memory which stores information on the extreme determined to be valid by the extreme validity determination section; and
a barcode width generation section which performs binarization processing on the basis of information on the extreme stored in the memory.

2. The barcode reader according to claim 1, wherein
the extreme validity determination section measures a time interval between a second extreme detected by the extreme detection section and a latest first extreme detected before the second extreme and stored in the memory, and when the time interval is greater than the predetermined time interval, the extreme validity determination section stores information on the second extreme in the memory.

3. The barcode reader according to claim 2, wherein the extreme detection section detects a maximal value when the first extreme is a minimal value, and detects the minimal value when the first extreme is the maximal value.

4. The barcode reader according to claim 2, wherein the predetermined interval is set to be shorter than a time interval between a peak and a bottom of a barcode signal, and is set to be longer than a time interval between a peak and a bottom of a noise signal.

5. The barcode reader according to claim 2, wherein whether or not binarization processing is executed for an extreme is determined, and the extreme validity determination section varies the predetermined time based on a result of determination.

6. The barcode reader according to claim 5 further comprising:
a frequency measurement section which measures the frequency of a barcode signal,
wherein the extreme validity determination section sets the time interval on the basis of the measured frequency of the barcode signal.

7. The barcode reader according to claim 6, wherein the predetermined time is calculated by use of at least one of: a minimal value of the frequency measured by the frequency measurement section, a maximal value of the frequency measured by the frequency measurement section, and an average value between the minimal and maximal values.

8. The barcode reader according to claim 1, wherein
the extreme validity determination section determines whether the number of data sampled in accordance with a sampling rate is greater than a predetermined number, the data being located between a second extreme detected by the extreme detection section and a latest first extreme detected before the second extreme and stored in the memory, and the extreme validity determination section stores information on the second extreme in the memory only when the number of data is greater than the predetermined number.

9. The barcode reader according to claim 8, wherein the predetermined number is set to be smaller than the number of sampling data present between a peak and a bottom of a barcode signal, and is set to be larger than the number of sampling data present between a peak and a bottom of a noise signal.

10. The barcode reader according to claim 1, wherein
when a second extreme detected by the extreme detection section and a latest first extreme detected before the second extreme and stored in the memory have the same polarity, the extreme validity determination section compares voltages of the first and second extremes, and determines that the extreme with a higher voltage is valid.

11. The barcode reader according to claim 10, wherein when both the first extreme and the second extreme are maximal values, the extreme validity determination section determines that the maximal value having a higher voltage is a valid extreme.

12. The barcode reader according to claim 10, wherein when both the first extreme and the second extreme are minimal values, the extreme validity determination section determines that the minimal value having a lower voltage is a valid extreme.

13. The barcode reader according to claim 10, wherein
when determining that the second extreme is valid, the extreme validity determination section stores information on the second extreme in the memory and deletes information on the first extreme from the memory.

14. A barcode reading method comprising the steps of:
scanning a barcode symbol with light by a light source and causing a sensor section to receive reflected light coming from the barcode symbol;
generating an electric signal from a received light signal and further generating a differential signal from the electric signal;
sequentially detecting extremes of the generated differential signal;
determining whether or not the detected extremes are valid;
causing a memory to store only information regarding extremes that are determined as valid in the determining step; and
executing binarization processing based on the information stored in the memory, thereby generating barcode width data.

15. The barcode reading method according to claim 14, further comprising the steps of:
measuring a time interval between a first extreme and a second extreme, the second extreme being an extreme which is currently detected, and the first extreme being an extreme which is detected prior to the second extreme and which is a latest one stored in the memory;
determining whether the measured time interval is longer than a predetermined time interval,
information regarding the second extreme being stored in the memory only when the time interval is longer than the predetermined time interval.

16. The barcode reading method according to claim 14, further comprising the steps of:
measuring a time interval between a first extreme and a second extreme, the second extreme being an extreme which is currently detected, and the first extreme being an extreme which is detected prior to the second extreme and which is a latest one stored in the memory;
determining whether the measured time interval is longer than a predetermined time interval,
information regarding the second extreme being discharged without being stored in the memory when the time interval is shorter than the predetermined time interval.
